(19) United States
(12) Patent Application Publication
(10) Pub. No.: US 2022/0201167 A1
(43) Pub. Date: Jun. 23, 2022

(54) CAMERA MODULE AND TERMINAL DEVICE

(71) Applicant: GUANGDONG OPPO MOBILE TELECOMMUNICATIONS CORP., LTD., Dongguan (CN)

(72) Inventor: Wei CHEN, Dongguan (CN)

(21) Appl. No.: 17/688,829

(22) Filed: Mar. 7, 2022

Related U.S. Application Data
(63) Continuation of application No. PCT/CN2020/115799, filed on Sep. 17, 2020.

(30) Foreign Application Priority Data
Oct. 14, 2019 (CN) 201910973649.4

(51) Int. Cl. H04N 5/225

(52) U.S. Cl. CPC H04N 5/2253; G02B 7/021; H04N 5/2257

(57) ABSTRACT

Disclosed are a camera module and a terminal device. The camera module includes a reflective element, a lens group, an image sensor, and a driving component. Light can be incident on the reflective element and reflected to the lens group by the reflective element. An extension direction of an optical axis of the lens group is parallel to or at an acute angle to a light incident surface of the reflective element. The light can travel through the lens group and be incident on the image sensor. The driving component includes a fluid element and a pressing element, the image sensor is connected to the fluid element, and the pressing element can press the fluid element to drive the fluid element to deform so as to drive the image sensor to move.

### CROSS-REFERENCE TO RELATED APPLICATION(S)

This application is a continuation of International Application PCT/CN2020/115799, filed Sep. 17, 2020, which claims priority to Chinese Patent Application No. 201910973649.4, filed Oct. 14, 2019, the entire disclosures of which are incorporated herein by reference.

### TECHNICAL FIELD

The present disclosure relates to the technical field of optical cameras, and particularly to a camera module and a terminal device.

### BACKGROUND

Mobile terminals such as smartphones are generally equipped with camera modules, and high-definition camera modules are increasingly becoming necessary to the mobile terminals. However, as the pixels of the camera module increase, the volume of the lens group increases accordingly. Therefore, a greater driving force is required for achieving the focusing or anti-shake of the camera modules. And the greater driving force causes the volume of the driving component to increase correspondingly, which is not conducive to the miniaturization of the camera modules.

### SUMMARY

In view of the above, it is necessary to provide a camera module and a terminal device.

A camera module, including: a reflective element, configured to reflect incident light; a lens group, configured to deliver the incident light reflected by the reflective element, and an extension direction of an optical axis is parallel to or at an acute angle to a light incidence surface of the reflective element; an image sensor, configured to capture the incident light delivered by the lens group; and a driving component including a fluid element and a pressing element, where the image sensor is coupled with the fluid element, and the fluid element is deformable based on displacement of the pressing element to move the image sensor.

A camera module, including: a reflective element, configured to receive incident light for the camera module; a lens group, where the lens group is arranged with one side thereof facing the reflective element, and the reflective element is configured to reflect the incident light to the lens group; an image sensor, arranged on an opposite of the lens group facing away from the reflective element; and a driving component including a fluid element and a pressing element, where the image sensor is coupled with the fluid element, and the pressing element is configured to press the fluid element to deform the fluid element, so as to drive the image sensor to move along an optical axis of the lens group or deflect.

A terminal device includes a housing and the above-mentioned camera module, and the camera module is arranged on the housing.

### BRIEF DESCRIPTION OF THE DRAWINGS

In order to more clearly describe the technical solutions of embodiments of the disclosure or those in the related art, drawings needed to be used in the description of the embodiments or the related art will be briefly introduced hereafter. Obviously, the drawings in the following illustrate only some embodiments of the disclosure, and those skilled in the art can obtain other drawings based on these drawings without any creative work.

FIG. 1 is a perspective view of a terminal device in an embodiment;

FIG. 2 is a cross-sectional view of a camera module in an embodiment;

FIG. 3 is a schematic diagram illustrating one state of a driving component of the camera module shown in FIG. 2;

FIG. 4 is a schematic diagram illustrating another state of the driving component of the camera module shown in FIG. 3;

FIG. 5 is a schematic diagram illustrating positions of the driving component, an image sensor, and a circuit board of the camera module in an embodiment;

FIG. 6 is a schematic diagram illustrating another state of the driving component of the camera module shown in FIG. 3;

FIG. 7 is a schematic diagram illustrating the positions of the driving component, the image sensor, and the circuit board of the camera module in another embodiment; and

FIG. 8 is a schematic diagram illustrating the structure of a terminal device in an embodiment of the disclosure.

### DETAILED DESCRIPTION OF PREFERRED EMBODIMENTS

In order to facilitate the understanding of the disclosure, the disclosure will be described below comprehensively with reference to the drawings. The drawings show preferred embodiments of the disclosure. However, this disclosure can be implemented in many different ways, rather than being limited to the embodiments described herein. On the contrary, the embodiments are provided just for the purpose of providing thorough and comprehensive understanding of the disclosure.

The term “terminal device” used herein refers to, but is not limited to, devices that can be connected in any one or some of the following connections to receive and/or send communication signals:

(1) Wired connection, for example, the connection is established via Public Switched Telephone Networks (PSTN), Digital Subscriber Line (DSL), a digital cable, and a direct cable; and

(2) Wireless connection, for example, the connection is established via cellular network, Wireless Local Area Network (WLAN), digital television network such as DVB-H network, satellite network, and AM-FM broadcast transmitter.

The terminal devices configured to communicate wirelessly may be referred to as “mobile terminals”. Examples of the mobile terminals include, but are not limited to, the following electronic devices:

(1) A satellite phone or cellular phone;

(2) A Personal Communications System (PCS) terminal that can incorporate a cellular radio telephone with capacities of data processing, fax and data communication;

(3) A radio telephone, pager, Internet/Intranet access, Web browser, note book, calendar, Personal Digital Assistant (PDA) equipped with a Global Positioning System (GPS) receiver;

(4) A conventional laptop and/or palmtop receiver; and

(5) A conventional laptop and/or palmtop radio telephone transceiver, etc.

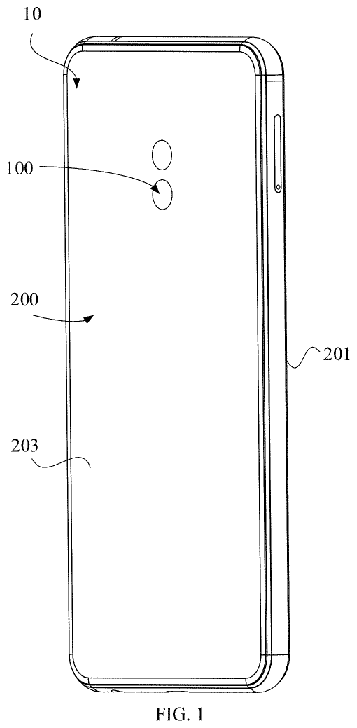

Referring to FIG. 1, in some embodiments, the terminal device 10 is a smart phone. The terminal device 10 includes a camera module 100 and a housing 200. The camera module 100 is disposed in the housing 200, and the camera module 100 may be configured for shooting. For example, in some embodiments, the camera module 100 can provide functions of a front camera, and the user can perform, through the camera module 100, operations such as taking a selfie and making a video call. In other embodiments, the camera module 100 can provide the functions of a rear camera, and the user can perform, through the camera module 100, operations such as close-range shooting, long-range shooting, and video recording. In other embodiments, the terminal device 10 may be a tablet computer, a notebook computer, or the like. Embodiments of the disclosure are described by taking a case where the camera module 100 is a smart phone as an example, but it is understandable that the camera module 100 disclosed in the disclosure is also applicable to other types of terminal devices 10.

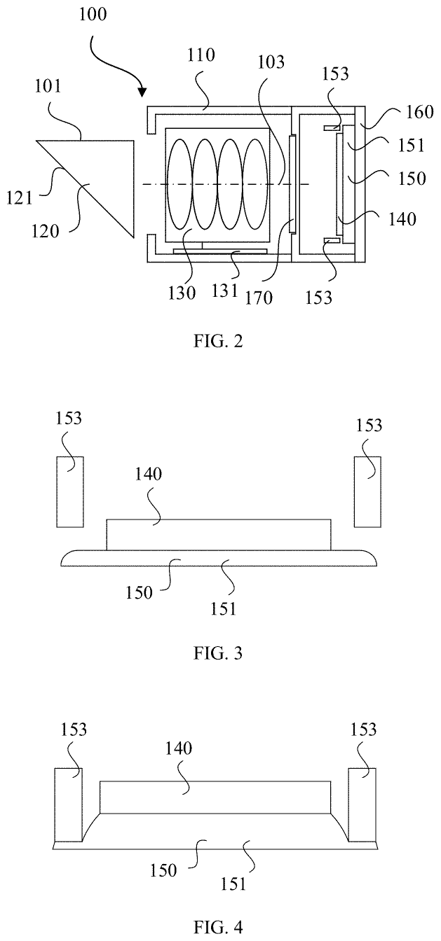

Referring to FIG. 2, the camera module 100 is embodied as a periscopic camera, that is, the light incidence surface 101 of the camera module 100 and the extending direction of the optical axis 103 of the camera module 100 are not perpendicular to each other. For example, referring to FIG. 1, the terminal device 10 includes a display surface 201 and a back surface 203 arranged opposite to each other. The display surface 201 can be configured to display information and provide an interactive interface for the user. The camera module 100 receives incident light from the back surface 203 of the terminal device 10, and the optical axis 103 of the camera module 100 is perpendicular to the thickness direction of the terminal device 10. Therefore, in the extending direction of the optical axis 103, the camera module 100 can have a relatively large length and width, to obtain a long focal length and get a better shooting quality. The camera module 100 of this structure can provide therein a relatively large space for the lenses to move, so as to realize optical zoom, thereby providing a better shooting quality and adapting to more shooting scenes.

Specifically, referring to FIG. 2, the camera module 100 includes a base 110, a reflective element 120, a lens group 130, an image sensor 140, and a driving component 150. The reflective element 120 and the lens group 130 are all mounted on and supported by the base 110. The reflective element 120 is configured for directing the incident light of the camera module 100. The light can be incident on the reflective element 120 and reflected by the reflective element 120 to the lens group 130. The lens group 130 is arranged in such a manner that one side of the lens group 130 faces an light exiting surface of the reflective element 120, and the opposite side of the lens group 130, that is away from the reflective element 120, faces the image sensor 140. The light travelling through the lens group 130 can be further incident on the image sensor 140, so as to convert the optical signal of the light into an electrical signal. After the electrical signal is further processed, an image of the subject can be obtained. The optical axis 103 is determined by the lens group 130, and the extending direction of the optical axis 103 is parallel to or at an acute angle to the light incidence surface 101 of the reflective element 120. The driving component 150 includes a fluid element 151 and a pressing element 153. The pressing element 153 is mounted on and movable relative to the base 110. The image sensor 140 is coupled with and in contact with the fluid element 151. The pressing element 153 can press the fluid element 151 to deform the fluid element 151, so as to drive the image sensor 140 to move.

The camera module 100 further includes a circuit board 160. The circuit board 160 is connected to the base 110, and the fluid element 151 is connected to the circuit board 160 and located between the image sensor 140 and the circuit board 160. The circuit board 160 is electrically connected with the image sensor 140. The circuit board 160 may be provided with a flexible circuit board, and be electrically connected to a main board of the terminal device 10 through the flexible circuit board, to transmit the image data collected by the camera module 100 to the processor of the terminal device 10 for further processing. Furthermore, the camera module 100 includes a filter element 170. The filter element 170 is installed on the base 110 and located between the lens group 130 and the image sensor 140. The filter element 170 can filter out infrared light, so that the camera module 100 can provide a better shooting quality.

In some embodiments, the reflective element 120 is substantially in a shape of triangular prism, and the reflective element 120, being a prism, includes a reflective surface 121 that is capable of totally reflecting the incident light received at the light incidence surface 101 of the reflective element 120. The total reflection enables the loss of the incident light after travelling through the reflective element 120 to be reduced, which is beneficial to the better shooting quality. In other embodiments, the reflective element 120, being a prism, includes the reflective surface 121, and the reflective surface 121 is coated with a reflective film to cause the light incident on the reflective surface 121 to be total reflected. In this implementation, the reflective film is an optical film and the processing thereof is relatively easy; therefore, the material requirements for the prism can be reduced, thereby reducing the manufacturing cost of the camera module 100 while providing a relatively high shooting quality.

The fluid element 151 includes a shell and a fluid. The shell is flexible and encloses the fluid therein. The fluid may be a liquid, a gas or a gas-liquid mixture, and is sealed in the shell. The shell may be connected to the image sensor 140 by bonding or other ways, so that the image sensor 140 is driven to move when the fluid element 151 is deformed. The pressing element 153 includes any one of a piezoelectric ceramic element and a magnetostrictive element. Specifically, the piezoelectric ceramic element can change its size under the action of an electric field. Therefore, by controlling the electric field, the pressing element 153 can apply a pressing force to the fluid element 151. The magnetostrictive element can deform through expansion and contraction under the action of a magnetic field. Therefore, by controlling the magnetic field with an electromagnet or other structure, the pressing element 153 can apply the pressing force to the fluid element 151. In some embodiments, the pressing element 153 includes an electromagnet and a permanent magnet. The electromagnet is fixedly mounted on the base 110, and the permanent magnet can move relative to the base 110. When the electromagnet is energized to produce a magnetic field, the permanent magnet can be driven to move and press the fluid element 151. Of course, the pressing element 153 may also include a permanent magnet and a coil. The permanent magnet is fixedly provided on the base 110 and configured to provide a magnetic field. The coil is connected to the base 110 and arranged in the magnetic field, and can move, when being energized, to press the fluid element 151.

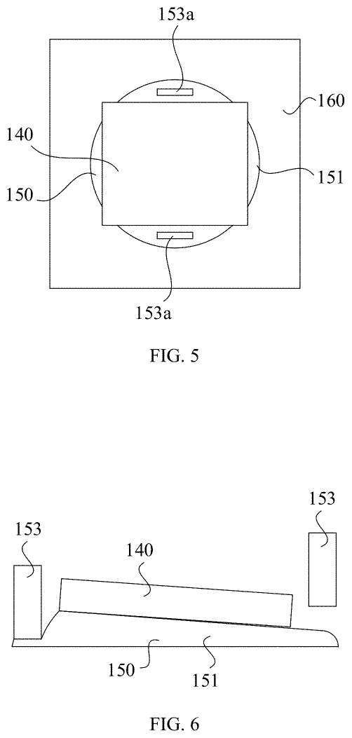

Referring to FIG. 3 and FIG. 4, in some embodiments, when the pressing element 153 presses the fluid element 151 to deform the fluid element 151, the image sensor 140 can be translated along the optical axis 103 to approach or move away from the lens group 130, where translation means that displacements of various parts of the image sensor 140 along the optical axis are equal. Specifically, referring to FIG. 5, in this embodiment, the pressing element 153 includes two first pressing elements 153a, and the two first pressing elements 153a are disposed at opposite ends of the fluid element 151. The two first pressing elements 153a can be controlled independently of each other, or can be controlled synchronously, in such a manner that the two first pressing elements 153a produce equal displacements at the same time, to cause the image sensor 140 to perform a translational movement in the extending direction of the optical axis 103. In the camera module 100 of this structure, since the pressing element 153 can be controlled to press the fluid element 151 to drive the image sensor 140 to translate along the optical axis 103 to approach or move away from the lens group 130, the focusing function can be realized. For example, when the object distance is changed, based on the imaging principle 1/f=1/u+1/v (where f is the focal length of the lens, u is the object distance, and v is the image distance), it can be known that the image distance should also be changed accordingly. By means of the driving component 150, the position of the image sensor 140 can be adjusted to meet the requirements for focusing. Referring to FIG. 5, in some embodiments, the two first pressing elements 153a may be arranged symmetrically relative to the optical axis 103. In other embodiments, the number of the first pressing element 153a may be more than two, so as to more conveniently and accurately control the deformation of the fluid element 151, and enable the driving component 150 to make a relatively fast response. Since the deformation of the fluid element 151 is easy to control, and the deformation of the fluid element can be achieved with a relatively small pressing force, the pressing element 153 can have relatively low power consumption, and the structure of the pressing element 153 can be relatively simple, easy to manufacture, and occupy a relatively small volume. In this way, the driving component 150 can provide a relatively large displacement and facilitate the miniaturization of the camera module 100, thereby facilitating the slim design of the terminal device 10.

Further, referring to FIG. 3 and FIG. 6, in some embodiments, when the pressing element 153 presses the fluid element 151 to deform the fluid element 151, the image sensor 140 can be deflected. Specifically, referring to FIG. 5 and FIG. 6, the two first pressing elements 153a can be independently controlled. And taking this case as an example, when one of the first pressing elements 153a presses the fluid element 151, and the other may not press the fluid element 151, the image sensor 140 can be deflected; alternatively, when the two first pressing elements 153a cause unequal displacements to the fluid element 151 through the pressing, the image sensor 140 can be deflected. In the camera module 100 of this structure, since the pressing element 153 can be controlled to press the fluid element 151 to drive the image sensor 140 to deflect, the anti-shake function can be realized, so that clear images can be captured even when the camera module 100 is shaking. For example, the terminal device 10 includes a gyroscope through which the amount of shaking of the terminal device 10 can be detected. When the terminal device 10 is shaking, the driving component 150 can compensate the image sensor 140 according to the amount of shaking, to obtain a clear captured image. Similarly, this anti-shake method can also gain a relatively fast response, and be beneficial to the slim design of the camera module 100 and the terminal device 10.

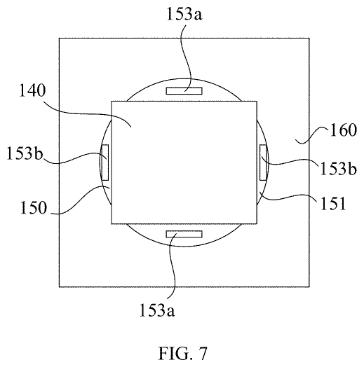

In the case where the two first pressing elements 153a are arranged at the two ends of the fluid element 151 and in central symmetry relative to the optical axis 103, the two first pressing elements 153a can be controlled to drive the image sensor 140 to deflect around a first axis, thereby enabling the anti-shake of the camera module 100 on the first axis. Of course, more than two first pressing elements 153a can be provided to achieve more precise control. Further, referring to FIG. 7, the pressing element 153 further includes two second pressing elements 153b that can be controlled independently of each other, and the two second pressing elements 153b and the two first pressing elements 153a are alternately arranged in a circumferential direction of fluid element 151 and spaced apart from each other. The two second pressing elements 153b are also arranged opposite to each other. The structure and working principle of the second pressing elements 153b may be similar to those of the first pressing elements 153a. The two second pressing elements 153b can also be configured for the focusing of the camera module 100. Specifically, when equal displacements are produced by the two first pressing elements 153a and the two second pressing elements 153b at the same time to deform the fluid element 151, the image sensor 140 can be driven to translate along the optical axis 103 to approach or move away from the lens group 130. Alternatively, when the two first pressing elements 153a are not enabled, and equal displacements are produced by the two second pressing elements 153b at the same time to deform the fluid element 151, the image sensor 140 can also be driven to translate along the optical axis 103 to approach or move away from the lens group 130. Furthermore, the two second pressing elements 153b can be controlled to drive the image sensor 140 to deflect around a second axis, thereby enabling the anti-shake of the camera module 100 on the second axis. The first axis and the second axis may be perpendicular to each other, or an acute angle may be defined between the first and second axes. For example, the first axis and the second axis may be both in a plane perpendicular to the optical axis 103. Furthermore, in the embodiments, the deflection of the image sensor 140 around the first axis and the deflection of the image sensor 140 around the second axis may be performed simultaneously, or at least one of the deflection of the image sensor 140 around the first axis and the deflection of the image sensor 140 around the second axis may be performed.

Taking a case where the first axis and the second axis are perpendicular to each other as an example, the central angles defined by every two adjacent pressing elements of the first pressing elements 153a and the second pressing elements 153b relative to the optical axis 103 are equal. For example, in an implementation in which there are two first pressing elements 153a and two second pressing elements 153b, each of the first pressing elements 153a and any of its adjacent second pressing elements 153b define a central angle of 90 degrees relative to the optical axis 103. This configuration enables the driving component 150 to be controlled more conveniently, for realizing the anti-shake of the camera module 100 on the first axis and the second axis, thereby obtaining a better anti-shake effect. The gyroscope of the terminal device 10 can detect the amount of shaking of the terminal device 10, and when the terminal device 10 is shaking, the image sensor 140 is compensated on the first axis and the second axis according to the amount of shaking to obtain a clear captured image. Similarly, this anti-shake method can also gain a relatively fast response, and be beneficial to the slim design of the camera module 100 and the terminal device 10.

In the above-mentioned camera module 100, the pressing element 153 can be controlled to press the fluid element 151 to deform the fluid element 151, thereby driving the image sensor 140 to move. The movement of the image sensor 140 enables the focusing or anti-shake function of the camera module 100 to be achieved. The driving component 150 has a relatively small volume and a simple structure, and the deformation of the fluid element is easy to control. Therefore, the movement of the image sensor 140 can be easily controlled with a relatively low power consumption, to obtain a faster focusing speed or a better anti-shake effect. The aforementioned driving component 150 is also applicable to large-volume lenses and large-area image sensors 140, and is beneficial to simplify the structure of the camera module 100, reduce the size of the camera module 100, and reduce the power consumption of the camera module 100.

Further, in some embodiments, the camera module 100 includes a voice coil motor 131. The voice coil motor is disposed on the base 110 and can drive the lens group 130 to move. Specifically, the voice coil motor includes a coil and a magnet. The coil is connected to the lens group 130, and the magnet is connected to the base 110 and configured to produce a magnetic field. When the coil is energized, it can drive the lens group 130 to move along the optical axis 103. Further, the voice coil motor can drive one or more of the lenses in the lens group 130 to move along the optical axis 103 to realize the optical zoom.

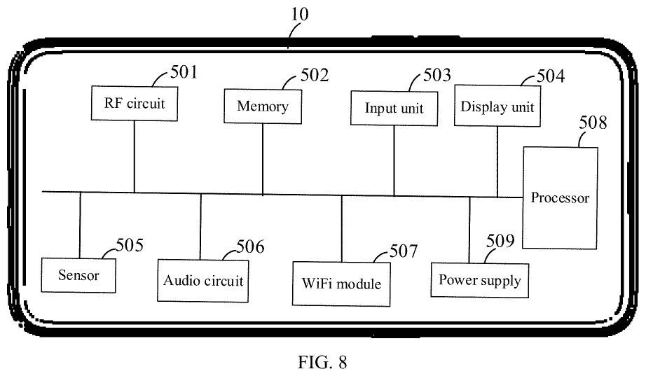

Referring to FIG. 8, FIG. 8 is a schematic structural diagram of a terminal device 10 provided by the embodiments of the disclosure. The terminal device 10 may include a radio frequency (RF) circuit 501, a memory 502 including one or more computer-readable storage media, an input unit 503, a display unit 504, a sensor 505, an audio circuit 506, a wireless fidelity (WiFi) module 507, a processor 508 with one or more processing cores, a power supply 509 and other components. Those skilled in the art can understand that the structure of the terminal device 10 shown in FIG. 8 does not limit the terminal device 10, more or less components than those shown in the figure can be included, or some of the components can be combined, or a different layout of the components can be adopted.

The radio frequency circuit 501 can be used to send and receive information, or to receive and send signals during a call. In particular, after receiving downlink information from a base station, the radio frequency circuit forwards such information to one or more processors 508 for processing; in addition, the radio frequency circuit sends uplink data to the base station. Generally, the radio frequency circuit 501 includes, but is not limited to, an antenna, at least one amplifier, a tuner, one or more oscillators, a Subscriber Identity Module (SIM) card, a transceiver, a coupler, and a low noise amplifier (LNA), a duplexer, etc. In addition, the radio frequency circuit 501 can also communicate with the network and other devices through wireless communication. The wireless communication can use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), Email, Short Message Service (SMS), etc.

The memory 502 can be used to store application programs and data. The application program stored in the memory 502 contains executable codes. Application programs can be composed of various functional modules. The processor 508 executes various functional applications and data processing by running the application programs stored in the memory 502. The memory 502 may mainly include a program storage area and a data storage area. The program storage area may store an operating system, an application program required by at least one function (such as a sound playback function, and an image playback function), and the like. The data storage area can store data created by the terminal device 10 in use (such as audio data, and phone book) and the like. In addition, the memory 502 may include a high-speed random access memory, and may also include a non-volatile memory such as at least one magnetic disk storage device or a flash memory device, or may include other volatile solid-state storage devices. Correspondingly, the memory 502 may further include a memory controller to provide access to the memory 502 for the processor 508 and the input unit 503.

The input unit 503 can be used to receive input number information, character information, or user characteristic information (such as fingerprints), and generate a keyboard input, mouse input, joystick input, optical or trackball signal input related to user settings and function control. Specifically, in a specific implementation, the input unit 503 may include a touch-sensitive surface and other input devices. The touch-sensitive surface is also called a touch screen or a trackpad, and can collect touch operations performed by the user on or near it (for example, operations that the user performs on or near the touch-sensitive surface with any suitable objects or accessories such as his/her finger(s) and a stylus), and drive a corresponding connection device according to the preset program. Optionally, the touch-sensitive surface may include two parts: a touch detection device and a touch controller. Among them, the touch detection device detects the user's touch position, detects the signal generated by the touch operation, and transmits the signal to the touch controller. The touch controller receives the touch information from the touch detection device, converts it into contact coordinates, and then sends them to the processor 508. The touch controller can also receive commands sent by the processor 508 and execute them.

The display unit 504 may be used to display information input by the user or information provided to the user, and various graphical user interfaces of the terminal device 10. These graphical user interfaces may be composed of graphics, text, icons, videos, and any combination thereof. The display unit 504 may include a display panel. Optionally, the display panel may be configured in the form of a Liquid Crystal Display (LCD), an Organic Light-Emitting Diode (OLED) and the like. Further, the touch-sensitive surface can cover the display panel. When the touch-sensitive surface detects a touch operation on or near it, it transmits information related to the operation to the processor 508 to determine the type of the touch event. Then, the processor 508 controls corresponding visual output to be provided on the display panel, according to the type of the touch event. Although the touch-sensitive surface and the display panel are used as two independent components to realize the input and input functions in FIG. 8, in some embodiments, the touch-sensitive surface and the display panel may be integrated to realize the input and output functions.

The terminal device 10 may also include at least one sensor 505, such as a light sensor, a motion sensor, and other sensors. Specifically, the light sensor may include an ambient light sensor and a proximity sensor. The ambient light sensor may be configured to adjust the brightness of the display panel according to the luminance of the ambient light, and the proximity sensor may be configured to close the display panel and/or backlight when the terminal device 10 is moved to the ear of the user. As one kind of the motion sensors, a gravity acceleration sensor can detect the magnitude of acceleration in various directions (usually in three axes), and can detect the magnitude and direction of gravity when it is stationary. The gravity acceleration sensor can be used for applications related to identification of the mobile phone posture (such as switching between landscape and portrait, related games, and calibration of magnetometer postures), functions related to vibration recognition (such as pedometer, and knocking), and the like. As for other sensors, such as gyroscope, barometer, hygrometer, thermometer, and infrared sensor, which can also configured for the terminal device 10, they will not be detailed here.

The audio circuit 506 can provide an audio interface between the user and the terminal device 10 through a speaker and a microphone. The audio circuit 506 can convert the received audio data into an electric signal, and transmit it to the speaker, so that the speaker converts it into a sound signal for output. In addition, the microphone converts the collected sound signal into an electric signal, and transmits it the audio circuit 506 for being converted into audio data. After being processed by the processor 508, the audio data is sent to for example another terminal device 10 through the radio frequency circuit 501, or output to the memory 502 for further processing. The audio circuit 506 may also include an earphone holder to provide communication between a peripheral earphone and the terminal device 10.

Wireless fidelity (WiFi) is a short-distance wireless transmission technology. Through the wireless fidelity module 507, the terminal device 10 can help users send and receive emails, browse webpages, and access streaming media. It provides users with wireless broadband Internet access. Although FIG. 8 shows the wireless fidelity module 507, it is understandable that this is not a necessary component of the terminal device 10, and can be omitted as needed without changing the essence of the disclosure.

The processor 508 is the control center of the terminal device 10. It uses various interfaces and lines to connect the various parts of the entire terminal device 10. By running or executing the applicant programs stored in the memory 502 and by invoking data stored in the memory 502, various functions and data processing of the terminal device 10 can be implemented to monitor the terminal device 10 as a whole. Optionally, the processor 508 may include one or more processing cores. Preferably, the processor 508 may integrate an application processor and a modem processor, where the application processor mainly processes the operating system, user interface, application programs, and the like, and the modem processor mainly deals with wireless communication. It can be understood that the foregoing modem processor may not be integrated into the processor 508.

The terminal device 10 also includes the power supply 509 for supplying power to the various components. Preferably, the power supply 509 may be logically connected to the processor 508 through a power management system, so that functions such as management of charging, discharging, and power consumption can be realized through the power management system. The power supply 509 may also include one or more of DC or AC power supplies, a recharging system, a power failure detection circuit, a power converter or inverter, a power status indicator and other devices.

Although not shown in FIG. 8, the terminal device 10 may also include a Bluetooth module or the like, which will not be detailed here. During specific implementation, each of the above modules can be implemented as independent entities, or can be combined arbitrarily as one or several entities.

The technical features of the above-mentioned embodiments can be combined arbitrarily. For concise, not all possible combinations of the various technical features in the above-mentioned embodiments are described. However, as long as there is no contradiction in the combination of these technical features, they should be considered as falling within the scope of this specification.

The above-mentioned embodiments only illustrate several implementations of the present disclosure, and the description thereof is relatively specific and detailed, but they should not be understood as limiting the scope of the disclosure. It should be noted that, for those of ordinary skill in the art, several modifications and improvements can also be made without departing from the concept of the present disclosure, and these all fall within the protection scope of the disclosure. Therefore, the protection scope of the disclosure should be subject to the appended claims.

What is claimed is:

1. A camera module, comprising:
a reflective element, configured to reflect incident light;
a lens group, configured to deliver the incident light reflected by the reflective element, and an extension direction of an optical axis of the lens group is parallel to or at an acute angle to a light incidence surface of the reflective element;
an image sensor, configured to capture the incident light delivered by the lens group; and
a driving component, comprising a fluid element and a pressing element, wherein the image sensor is coupled with the fluid element, and the fluid element is deformable based on displacement of the pressing element to move the image sensor.

2. The camera module as claimed in claim 1, wherein the fluid element comprises a shell and a fluid, the shell is flexible and encloses the fluid therein, and the shell is connected to the image sensor; and
the pressing element comprises two first pressing elements respectively disposed at two opposite ends of the fluid element.

3. The camera module as claimed in claim 2, wherein when the two first pressing elements are controlled to produce equal displacements at the same time to the fluid element, the image sensor is movable along the optical axis of the lens group.

4. The camera module as claimed in claim 2, wherein when the two first pressing elements are controlled to produce unequal displacements to the fluid element, the image sensor is deflectable around a first axis.

5. The camera module as claimed in claim 4, wherein when only one of the two first pressing elements is controlled to deform the fluid element, the image sensor is deflectable around the first axis.

6. The camera module as claimed in claim 2, wherein the pressing element further comprises two second pressing elements, the two second pressing elements and the two first pressing elements are arranged alternatively along a circumferential direction of the fluid element and spaced apart from each other, and the two second pressing elements are arranged opposite to each other; and
wherein central angles defined by every two adjacent pressing elements of the first pressing elements and the second pressing elements with respect to the optical axis are equal.

7. The camera module as claimed in claim 6, wherein when the two first pressing elements and the two second pressing elements are controlled to produce equal displacements at the same time to the fluid element, the image sensor is movable along the optical axis of the lens group.

8. The camera module as claimed in claim 7, wherein when the two second pressing elements are controlled to produce unequal displacements to the fluid element, the image sensor is deflectable around a second axis, the second axis being different from a first axis, the fluid element being deflectable under pressure of the two first pressing elements.

9. The camera module as claimed in claim 8, wherein when only one of the two second pressing elements is controlled to deform the fluid element, the image sensor is deflectable around the second axis.

10. The camera module as claimed in claim 9, wherein the first axis is perpendicular to the second axis, or the first axis is at an acute angle to the second axis.

11. The camera module as claimed in claim 6, wherein the two first pressing elements are independently controlled to drive the image sensor to move or to deflect around a first axis, and the two second pressing elements are independently controlled to drive the image sensor to move or to deflect around a second axis, the first axis being different from the second axis.

12. The camera module as claimed in claim 1, wherein the camera module further comprises:
a base on which the reflective element, the lens group and the pressing element are mounted;
a circuit board, the circuit board being connected to the base and electrically connected to the image sensor, and the fluid element being connected to the circuit board and located between the image sensor and the circuit board; and
a filter element, the filter element being mounted on the base and located between the lens group and the image sensor.

13. The camera module as claimed in claim 12, wherein the camera module further comprises a voice coil motor, and the voice coil motor is arranged on the base and configured to drive the lens group to move along the optical axis.

14. The camera module as claimed in claim 12, wherein the lens group comprises a plurality of lenses, the camera module further comprises a voice coil motor, and the voice coil motor is arranged on the base and configured to drive at least one of the lenses to move along the optical axis.

15. The camera module as claimed in claim 1, wherein the pressing element comprises any one selected from a group consisting of a piezoelectric ceramic element and a magnetostrictive element.

16. The camera module as claimed in claim 12, wherein the pressing element comprises an electromagnet and a permanent magnet, the electromagnet is fixedly connected to the base, and the electromagnet is configured to, when being energized, drive the permanent magnet to move relative to the base, to press the fluid element.

17. The camera module as claimed in claim 12, wherein the pressing element comprises a permanent magnet and a coil, the permanent magnet is fixedly connected to the base and configured to produce a magnetic field, the coil is connected to the base and arranged in the magnetic field, and the coil is enabled to move when being energized, to press the fluid element.

18. The camera module as claimed in claim 1, wherein the reflective element is a prism and comprises a reflective surface, and the reflective surface is capable of totally reflecting the incident light, or the reflective surface is coated with a reflective film to cause light incident on the reflective surface to be totally reflected.

19. A camera module, comprising:
a reflective element, configured to receive incident light for the camera module;
a lens group, wherein the lens group is arranged with one side thereof facing the reflective element, and the reflective element is configured to reflect the incident light to the lens group;
an image sensor, arranged on an opposite side of the lens group facing away from the reflective element; and
a driving component comprising a fluid element and a pressing element, wherein the image sensor is coupled with the fluid element, and the pressing element is configured to press the fluid element to deform the fluid element, so as to drive the image sensor to move along an optical axis of the lens group or deflect.

20. A terminal device, comprising:
a housing; and
a camera module arranged in the housing, the camera module comprising:
a reflective element, configured to receive incident light for the camera module;
a lens group, configured to receive reflected incident light from the camera module, an extension direction of an optical axis of the lens group is parallel to or at an acute angle to a light incidence surface of the reflective element;
an image sensor, configured to receive the light traveling through the lens group; and
a driving component comprising a fluid element and a pressing element, wherein the image sensor is coupled with the fluid element, and the pressing element is configured to press the fluid element to deform the fluid element, so as to drive the image sensor to move.
